(19) United States
(12) Patent Application Publication
(10) Pub. No.: US 2026/0164112 A1
(43) Pub. Date: Jun. 11, 2026

(54) OBJECT RECOGNITION DEVICE AND OBJECT RECOGNITION METHOD

(71) Applicant: VIA Technologies, Inc., New Taipei City (TW)

(72) Inventors: Kuo-Han Chang, New Taipei City (TW); Yeh Cho, New Taipei City (TW); Shu-Cheng Chi, New Taipei City (TW); Chia-Hua Wu, New Taipei City (TW); Chun-Yi Wu, New Taipei City (TW); Yu-Ching Lo, New Taipei City (TW); Fan-Hao-Chi Fang, New Taipei City (TW)

(73) Assignee: VIA Technologies, Inc., New Taipei City (TW)

(21) Appl. No.: 19/292,828

(22) Filed: Aug. 6, 2025

Related U.S. Application Data
(60) Provisional application No. 63/729,966, filed on Dec. 10, 2024.
(60) Provisional application No. 63/742,863, filed on Jan. 8, 2025.

(30) Foreign Application Priority Data
Jun. 25, 2025 (TW) 114123902

(51) Int. Cl. H04N 23/61; G06V 10/70; G06V 30/19; G06V 30/24; H04N 23/695

(52) U.S. Cl. CPC H04N 23/61; G06V 10/70; G06V 30/191; G06V 30/24; H04N 23/695

(57) ABSTRACT

An object recognition device and an object recognition method are provided. The object recognition device includes an image sensor, a motorized pan-tilt mechanism, at least one marker, and a computing host. The image sensor senses an imaging region to generate an image data. The motorized pan-tilt mechanism rotates the image sensor to adjust the imaging region. The at least one marker is fixed to the motorized pan-tilt mechanism. The computing host determines whether the at least one corresponding marker appears in a specific region on a frame corresponding to the image data. In response to the corresponding marker not appearing in the specific region, the computing host suspends an object recognition on the frame corresponding to the image data. In response to the corresponding marker appearing in the specific region, the computing host starts to perform the object recognition on the frame corresponding to the image data.

### CROSS-REFERENCE TO RELATED APPLICATION

This application claims the priority benefit of U.S. provisional application Ser. No. 63/729,966, filed on Dec. 10, 2024, U.S. provisional application Ser. No. 63/742,863, filed on Jan. 8, 2025, and Taiwan application serial no. 114123902, filed on Jun. 25, 2025. The entirety of each of the above-mentioned patent applications is hereby incorporated by reference herein and made a part of this specification.

### BACKGROUND

### Technical Field

The disclosure relates to a vision-based technology for object detection, and particularly relates to an object recognition device and an object recognition method.

### Related Art

Object recognition technology is a major research topic in automation technology. Object recognition technology may be implemented by utilizing a color image (such as a RGB image) or a thermal image combined with artificial intelligence (AI) technology. A camera configured to capture an image is often fixed in a specific position, and use a rotatable base (such as a pan-tilt mechanism) to expand a detection range of the camera.

However, the image captured by the camera during rotation may cause misjudgment by artificial intelligence technology, resulting in a higher misjudgment probability, thereby reducing object recognition accuracy. For example, object recognition technology is configured to detect whether there is flame in a field. When there is a red object in the field, and the camera captures an image of the red object during rotation, artificial intelligence technology might mistakenly identify that there is flame in the image.

On the other hand, establishing the hardware for object recognition technology is costly. How to reduce hardware establishment costs is also a major topic. If a motion state of a pan-tilt mechanism configured to carry a camera is to be precisely controlled, additional hardware equipment and software development may be needed, increasing the cost and complexity of the system itself. Therefore, how to reduce the misjudgment probability of object recognition technology and enhance the object recognition accuracy while reducing the hardware establishment costs is one of the problems to be solved.

### SUMMARY

The disclosure provides an object recognition device and an object recognition method, which can enhance object recognition accuracy and reduce hardware establishment costs by performing a character recognition using a marker fixed to a motorized pan-tilt mechanism to determine whether a rotation position of an image sensor is at an appropriate position and determine whether to perform an object recognition on an image data.

The object recognition device of the disclosure includes an image sensor, a motorized pan-tilt mechanism, at least one marker, and a computing host. The image sensor senses an imaging region to generate an image data. The image sensor is disposed on the motorized pan-tilt mechanism. The motorized pan-tilt mechanism is configured to rotate the image sensor to adjust the imaging region of the image sensor. The at least one marker is fixed to the motorized pan-tilt mechanism. The computing host is coupled to the image sensor and controls the motorized pan-tilt mechanism. The computing host receives the image data from the image sensor. The computing host determines whether the at least one corresponding marker appears in at least one specific region on a frame corresponding to the image data. In response to the at least one corresponding marker not appearing in the at least one specific region, the computing host suspends an object recognition on the frame corresponding to the image data. In response to the at least one corresponding marker appearing in the at least one specific region, the computing host starts to perform the object recognition on the frame corresponding to the image data.

The object recognition method of the disclosure includes: an image sensor is used to sense an imaging region to generate an image data; the image sensor is disposed on a motorized pan-tilt mechanism; the motorized pan-tilt mechanism is configured to rotate the image sensor to adjust the imaging region of the image sensor; at least one marker is fixed to the motorized pan-tilt mechanism; the image data is received from the image sensor; whether the at least one corresponding marker appears in at least one specific region on a frame corresponding to the image data is determined; an object recognition on the frame corresponding to the image data is suspended in response to the at least one corresponding marker not appearing in the at least one specific region; and the object recognition on the frame corresponding to the image data is started to be performed in response to the at least one corresponding marker appearing in the at least one specific region.

Based on the above, the object recognition device and the object recognition method described in the embodiments of the disclosure use the marker fixed to the motorized pan-tilt mechanism and an optical character recognition (OCR) technology to determine the rotation position of the image sensor. If the corresponding marker appears in the specific region on the frame corresponding to the image data, the motorized pan-tilt mechanism is controlled to stop rotating. The object recognition is performed on the frame to avoid using a frame captured while the image sensor is rotated for object detection, thereby enhancing the object recognition accuracy, maximizing a monitoring range of the image sensor, and improving monitoring efficiency. On the other hand, the motorized pan-tilt mechanism does not need to feedback any signal to the computing host of the object recognition device, thus reducing the hardware establishment costs of the object recognition device.

### BRIEF DESCRIPTION OF THE DRAWINGS

FIG. 1 is a schematic diagram of an object recognition device according to an embodiment of the disclosure.

FIG. 2 is a schematic diagram showing the appearance of the image sensor, the motorized pan-tilt mechanism, the marker bracket, and the multiple markers in FIG. 1.

FIG. 3 is a flowchart of an object recognition method according to an embodiment of the disclosure.

FIG. 4 to FIG. 7 are schematic diagrams of an object recognition device in different scenarios.

### DESCRIPTION OF THE EMBODIMENTS

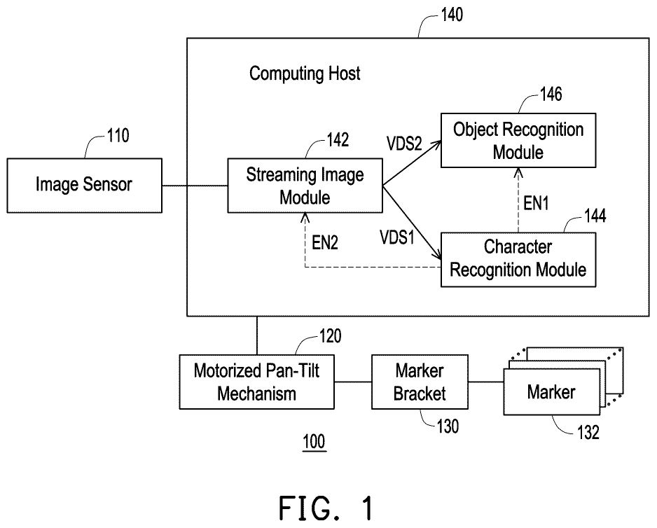

FIG. 1 is a schematic diagram of an object recognition device 100 according to an embodiment of the disclosure. The object recognition device 100 is mainly configured to recognize whether a specific object (such as flame or smoke generated by a specific gas that might be leaked) appears in an imaging region. The object recognition device 100 may be disposed in fields such as factories or public places, and configured for monitoring and early warning of abnormal events such as fires or gas leaks. The object recognition device 100 may be applied to various artificial intelligence (AI) recognition application scenes, such as industrial safety protection, security monitoring, autonomous driving, or industrial inspection.

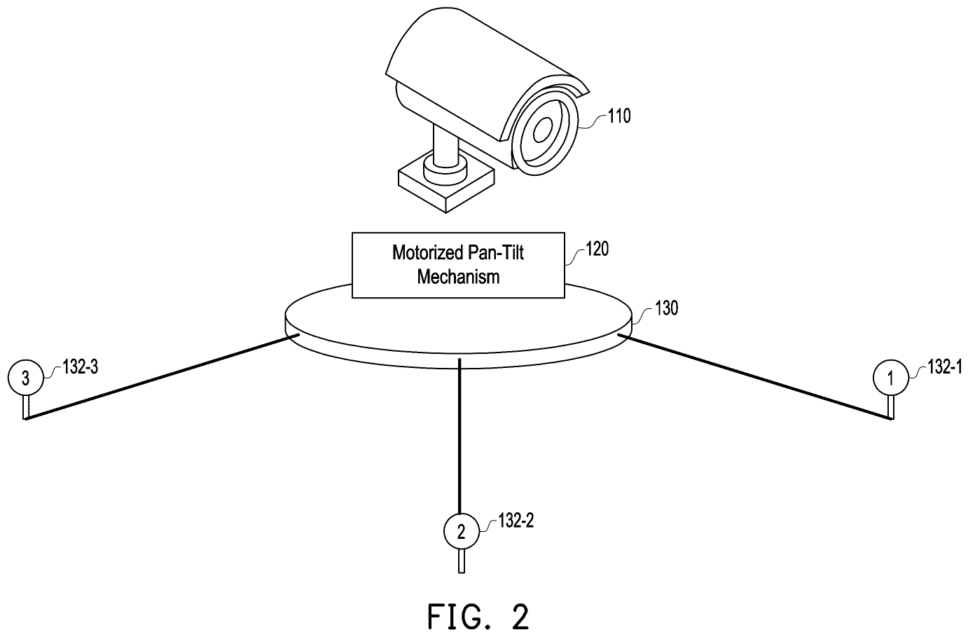

The object recognition device 100 mainly includes an image sensor 110, a motorized pan-tilt mechanism 120, at least one marker 132 (in the embodiment, three markers 132-1 to 132-3 in FIG. 2 are taken as an example, which will be described in details later), and a computing host 140. The object recognition device 100 further includes a marker bracket 130. The image sensor 110 is configured to sense an imaging region to generate an image data. The image sensor 110 may be a camera configured to capture a RGB image, or may be a sensor configured to capture a thermal image. The image sensor 110 may have a camera lens with a single focal length.

FIG. 2 is a schematic diagram of the image sensor 110, the motorized pan-tilt mechanism 120, the marker bracket 130, and the multiple markers 132-1 to 132-3 in FIG. 1. Please refer to FIG. 1 and FIG. 2 at the same time. The image sensor 110 is disposed on the motorized pan-tilt mechanism 120. The motorized pan-tilt mechanism 120 is controlled by the computing host 140, thereby rotating the image sensor 110 to adjust an imaging region of the image sensor 110. The motorized pan-tilt mechanism 120 has a corresponding mechanism that carries the image sensor 110 and a motor configured to rotate the image sensor 110. A control signal of the motor may come from the computing host 140.

The marker bracket 130 fixes the at least one marker 132 (such as the three markers 132-1 to 132-3 in FIG. 2) to the motorized pan-tilt mechanism 120. The marker 132 (such as the three markers 132-1 to 132-3 in FIG. 2) does not rotate simultaneously with a rotation of the image sensor 110. The marker 132 (such as the three markers 132-1 to 132-3 in FIG. 2) is fixed to the motorized pan-tilt mechanism 120.

The marker 132 (such as the three markers 132-1 to 132-3 in FIG. 2) presents one or a combination of numbers, text, and symbols in a direction facing the image sensor 110. In the embodiment of FIG. 2, the marker 132-1 presents, for example, a number “1”, the marker 132-2 presents, for example, a number “2”, and the marker 132-3 presents, for example, a number “3”. Those applying the embodiment may also present different text, symbols, etc. on the marker 132 as long as the numbers, text, and symbols on the marker 132 may be determined using a character recognition module 144, thereby allowing the computing host 140 to use the marker 132 to recognize whether a rotation position of the image sensor 110 is at an appropriate position.

Returning to FIG. 1, the computing host 140 may be a host including a processor, such as a personal computer or a server device. The computing host 140 of the embodiment is configured to run multiple software modules (such as a streaming image module 142, the character recognition module 144, and an object recognition module 146) to implement the embodiments of the disclosure. The character recognition module 144 of the embodiment may be an optical character recognition (OCR) artificial intelligence module. The object recognition module 146 may be a corresponding software algorithm module that performs the foregoing object recognition based on an artificial intelligence algorithm.

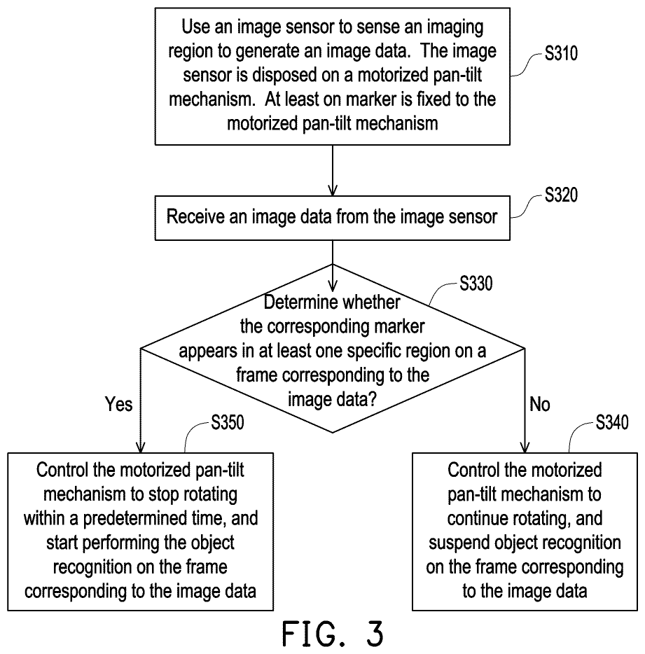

FIG. 3 is a flowchart of an object recognition method according to an embodiment of the disclosure. The object recognition method described in FIG. 3 is adapted to the object recognition device 100 in FIG. 1 and FIG. 2. Please refer to FIG. 1 and FIG. 3. In step S310, the image sensor 110 is used to sense an imaging region to generate an image data. The image sensor 110 of the embodiment is disposed on the motorized pan-tilt mechanism 120. The motorized pan-tilt mechanism 120 is configured to rotate the image sensor 110 to adjust the imaging region of the image sensor 110. The at least one marker 132 is fixed to the motorized pan-tilt mechanism 120.

In step S320, the computing host 140 receives the image data from the image sensor 110. In detail, the streaming image module 142 in the computing host 140 receives the image data, processes the image data into a first streaming image VDS1 to provide to the character recognition module 144, and processes the image data into a second streaming image VDS2 to provide to the object recognition module 146. The first streaming image VDS1 and the second streaming image VDS2 of the embodiment are equivalent to the image data provided by the image sensor 110.

In step S330, the computing host 140 determines whether at least one corresponding marker appears in at least one specific region on a frame corresponding to the image data. In detail, the computing host 140 uses the character recognition module 144 to determine whether the at least one corresponding marker appears in the at least one specific region on the frame of the first streaming image VDS1. In different scenarios, a positional relationship between a marker and a corresponding object to be detected may vary, so in the embodiment, multiple specific regions may be disposed in a preset frame, and each of the specific regions respectively corresponds to a different marker, thereby allowing the computing host 140 to determine whether a rotation position of the image sensor 110 has reached an appropriate position configured to detect the corresponding object to be detected by whether the corresponding markers appear in the different set regions. That is to say, each of the specific regions in the frame respectively corresponds to each of the markers. The computing host 140 recognizes the object to be detected in the imaging region based on the specific regions and the corresponding markers.

When step S330 is no, that is, in response to the corresponding marker not appearing in each of the specific regions on the frame of the first streaming image VDS1, the process proceeds from step S330 to step S340. The computing host 140 suspends an object recognition on the frame corresponding to the image data. In a first embodiment of the disclosure, the motorized pan-tilt mechanism 120 is still rotating and has not yet reached a predetermined position. At this time, the frame in the image data sensed by the image sensor 110 might be blurry and cause misjudgment by the object recognition module 146. Therefore, the computing host 140 suspends a recognition operation of the object recognition module 146 on the image data from the image sensor 110, avoiding misjudgment by the object recognition module 146. The computing host 140 may further control the motorized pan-tilt mechanism 120 to continue rotating. In the embodiment, when step S330 is no, the character recognition module 144 may not provide an enable signal EN1 to the object recognition module 146, so that the object recognition module 146 suspends operation. After step S340 is completed, the process returns to step S330 to continue the embodiment.

In a second embodiment of the disclosure, another practical approach for “suspending the recognition operation of the object recognition module 146 on the image data from the image sensor 110” may be to control the streaming image module 142 to temporarily stop transmitting the second streaming image VDS2 to the object recognition module 146 of the computing host 140. In detail, in step S340, the streaming image module 142 temporarily stops transmitting the second streaming image VDS2 to the object recognition module 146 of the computing host 140 based on an enable signal EN2, so that the object recognition module 146 suspends the object recognition on the frame corresponding to the image data.

In a third embodiment of the disclosure, another practical approach for “suspending the recognition operation of the object recognition module 146 on the image data from the image sensor 110” may be to adjust the second streaming image VDS2 to a sample image data pre-stored in the streaming image module 142 (such as an image data with an all-black frame or an all-white frame), and provide the sample image data to the object recognition module 146 of the computing host 140 at this time. Although the object recognition module 146 is still in the recognition operation, since the data transmitted to the object recognition module 146 is changed to the sample image data that does not include the object to be detected, the object recognition module 146 may not recognize the object to be detected and therefore may not sound an alarm. In other words, the streaming image module 142 adjusts the second streaming image VDS2 to the foregoing sample image data based on the enable signal EN2, and transmits the foregoing sample image data to the object recognition module 146 of the computing host 140, so that the object recognition module 146 suspends the object recognition on the frame corresponding to the image data and instead identifies the foregoing sample image data. In the embodiment, since the object recognition module 146 continues to operate and identify the sample image data, the system administrator does not need to confirm whether the object recognition module 146 suspends operation due to module failure or intentional non-operation. In this way, the third embodiment can also solve the problem of possible misjudgment and false alarms by the object recognition module 146.

On the other hand, when step S330 is yes, that is, in response to the corresponding marker appearing in one of the specific regions on the frame of the first streaming image VDS1, the process proceeds from step S330 to step S350. The computing host 140 starts to perform the object recognition on the frame corresponding to the image data. The computing host 140 may further control the motorized pan-tilt mechanism 120 to stop rotating within a predetermined time. In the embodiment, when step S330 is yes, the character recognition module 144 provides the enable signal EN1 to the object recognition module 146, so that the object recognition module 146 performs the object recognition according to the second streaming image VDS2 after obtaining the enable signal EN1. Alternatively, when step S330 is yes, the character recognition module 144 provides the enable signal EN2 to the streaming image module 142. After the character recognition module 144 obtains the enable signal EN2, the image data from the image sensor 110 is processed into the second streaming image VDS2 to provide to the object recognition module 146, so that the object recognition module 146 performs the object recognition according to the second streaming image VDS2.

In the embodiment, since it might take a period of predetermined time for the computing host 140 to control the motorized pan-tilt mechanism 120 to stop rotating, in the embodiment, after a “stop rotating” command is issued to the motorized pan-tilt mechanism 120, the motorized pan-tilt mechanism 120 is stopped from rotating after a short time period, and then the object recognition module 146 is controlled to perform the object recognition on the second streaming image VDS2. At this time, the frame and the object to be detected on the second streaming image VDS2 (that is, the image data provided by the image sensor 110) may not be distorted or blurred due to the rotation of the motorized pan-tilt mechanism 120, thereby reducing a misjudgment probability and improving object recognition accuracy. After the foregoing predetermined time, step S350 returns to step S330 to proceed with the embodiment.

In the embodiment, a distance between a camera lens of the image sensor 110 and the marker 132 (such as the three marks 132-1 to 132-3 in FIG. 2) may be maintained at around 20 centimeters. A distance between the camera lens of the image sensor 110 and the object to be detected is approximately between 6 meters and 20 meters. That is, the distance between the camera lens of the image sensor and the marker is much less than the distance between the camera lens of the image sensor and the object to be detected.

Due to a significant difference in the foregoing distances, the marker may experience a defocus phenomenon when being imaged on the camera lens of the image sensor 110. The embodiment addresses the foregoing problem and performs some optimizations on the character recognition module 144. For example, the character recognition module 144 of the embodiment may include a reference data with limited vocabularies. The foregoing limited vocabularies may only show numbers, text, or symbols located on the marker 132. The embodiment establishes the foregoing reference data in the character recognition module 144, which is similar to a dictionary with limited vocabularies, to allow the character recognition module 144 to more quickly recognize the corresponding marker 132 from the foregoing reference data. On the other hand, the character recognition module 144 of the embodiment may further include a training dataset related to the foregoing reference data. The training dataset may include an image on the marker 132 that has been processed with defocusing, blurring, etc., thereby enhancing an identification generalization ability of the character recognition module 144 for a defocused image. Furthermore, the training dataset in the character recognition module 144 may further include an image on the marker 132 that has undergone other image processing (such as rotation, deformation, partial cropping, or different types of blurring).

FIG. 4 to FIG. 7 are schematic diagrams of an object recognition device in different scenarios. Middle portions of FIG. 4 to FIG. 7 present the image sensor 110 and the three markers 132-1 to 132-3, and objects to be detected M1 to M3 are roughly sketched. Lower right portions of FIG. 4 to FIG. 7 present frames 410 to 710 presented by the image data in the image sensor 110. The frames 410 to 710 present specific regions SA1 to SA3 configured to be taken as examples, some of the markers 132-1 to 132-3, and some of the objects to be detected MI1 to MI3 located in an imaging region.

In the embodiment of FIG. 4, the specific regions SA1 to SA3 in the frame 410 do not have corresponding markers, therefore the computing host 140 in FIG. 1 may control the motorized pan-tilt mechanism 120 to continue to allow the image sensor to rotate, and temporarily not perform an object recognition on the frame 410 corresponding to the image data.

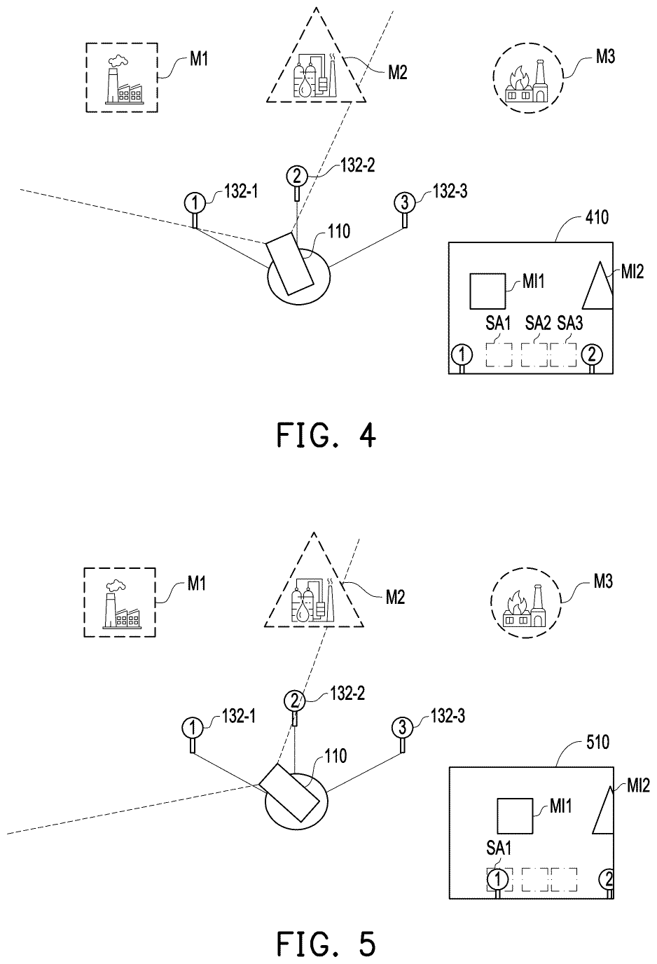

In the embodiment of FIG. 5, the specific region SA1 in the frame 410 has the number 1 corresponding to the marker 132-1, therefore the computing host 140 in FIG. 1 may control the motorized pan-tilt mechanism 120 to stop rotating within a predetermined time, and allow the object recognition module 146 to perform the object recognition on the frame 510 in the second streaming image VDS2. That is, in FIG. 5, through optimization by the character recognition module 144, the number 1 of the marker 132-1 may be focused and identifiable even there is an excessive difference between a distance from the image sensor 110 to the marker 132-1 and a distance from the image sensor 110 to the objects to be detected MI1 and MI2. When the number 1 of the marker 132-1 is recognized, the object recognition module 146 may perform the object recognition on the objects to be detected MI1 and MI2 in the frame 510 to determine whether an abnormal event (such as fire or specific gas leakage) has occurred.

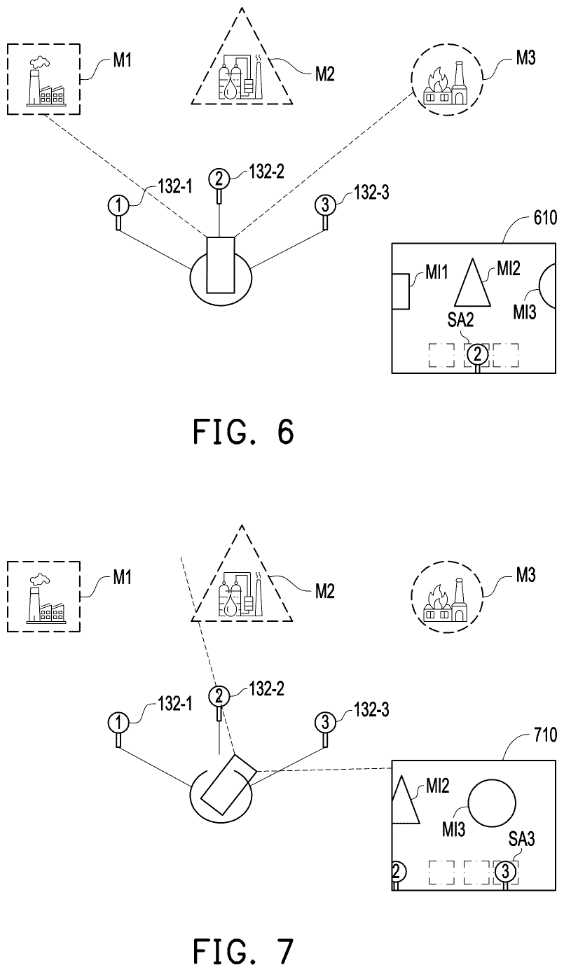

In the embodiment of FIG. 6, the specific region SA2 in the frame 410 has the number 2 corresponding to the marker 132-2, therefore the computing host 140 in FIG. 1 may control the motorized pan-tilt mechanism 120 to stop rotating within a predetermined time, and allow the object recognition module 146 to perform the object recognition on the frame 610 in the second streaming image VDS2. That is, in FIG. 6, through optimization by the character recognition module 144, the number 2 of the marker 132-2 maybe focused and identifiable even there is an excessive difference between a distance from the image sensor 110 to the marker 132-2 and a distance from the image sensor 110 to the objects to be detected MI1 to MI3. When the number 2 of the marker 132-2 is recognized, the object recognition module 146 may perform the object recognition on the objects to be detected MI1 to MI3 in the frame 610 to determine whether an abnormal event (such as fire or specific gas leakage) has occurred.

In the embodiment of FIG. 7, the specific region SA3 in the frame 410 has the number 3 of the corresponding marker 132-3, therefore the computing host 140 in FIG. 1 may control the motorized pan-tilt mechanism 120 to stop rotating within a predetermined time, and allow the object recognition module 146 to perform the object recognition on the frame 710 in the second streaming image VDS2. That is, in FIG. 7, through optimization by the character recognition module 144, the number 3 of the marker 132-3 may be focused and identifiable even there is an excessive difference between a distance from the image sensor 110 to the marker 132-3 and a distance from the image sensor 110 to the objects to be detected MI2 and MI3. When the number 3 of the marker 132-3 is recognized, the object recognition module 146 may perform the object recognition on the objects to be detected MI2 and MI3 in the frame 710 to determine whether an abnormal event (such as fire or specific gas leakage) has occurred.

In summary, the object recognition device and the object recognition method described in the embodiments of the disclosure use the marker fixed to the motorized pan-tilt mechanism and the optical character recognition (OCR) technology to determine the rotation position of the image sensor. When the corresponding marker appears in the specific region on the frame corresponding to the image data, the motorized pan-tilt mechanism is controlled to stop rotating. The object recognition is performed on the frame to avoid using a frame captured while the image sensor is rotated to perform object detection, thereby enhancing the object recognition accuracy, maximizing a monitoring range of the image sensor, and improving monitoring efficiency. On the other hand, the motorized pan-tilt mechanism does not need to feedback any signal to the computing host of the object recognition device, thus reducing the hardware establishment costs of the object recognition device.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An object recognition device, comprising:
an image sensor, sensing an imaging region to generate an image data;
a motorized pan-tilt mechanism, wherein the image sensor is disposed on the motorized pan-tilt mechanism, and the motorized pan-tilt mechanism is configured to rotate the image sensor to adjust the imaging region of the image sensor;
at least one marker, fixed to the motorized pan-tilt mechanism; and
a computing host, coupled to the image sensor and controlling the motorized pan-tilt mechanism, wherein the computing host receives the image data from the image sensor,
determining whether the at least one corresponding marker appears in at least one specific region on a frame corresponding to the image data,
in response to the at least one corresponding marker not appearing in the at least one specific region, the computing host suspends an object recognition on the frame corresponding to the image data, and
in response to the at least one corresponding marker appearing in the at least one specific region, the computing host starts to perform the object recognition on the frame corresponding to the image data.

2. The object recognition device according to claim 1, wherein, in response to the at least one corresponding marker not appearing in the at least one specific region, the computing host controls the motorized pan-tilt mechanism to continue rotating, and
in response to the at least one corresponding marker appearing in the at least one specific region, the computing host controls the motorized pan-tilt mechanism to stop rotating within a predetermined time.

3. The object recognition device according to claim 1, wherein each of the at least one marker presents one or a combination of numbers, text, or symbols in a direction facing the image sensor.

4. The object recognition device according to claim 1, wherein the at least one specific region in the frame respectively corresponds to the at least one marker, and the computing host recognizes an object to be detected in the imaging region based on the at least one specific region and the at least one marker.

5. The object recognition device according to claim 4, wherein a distance between a camera lens of the image sensor and the at least one marker is less than a distance between the camera lens of the image sensor and the object to be detected.

6. The object recognition device according to claim 1, wherein the computing host is configured to run:
a streaming image module, processing the image data into a first streaming image and a second streaming image, wherein the first streaming image and the second streaming image are equivalent to the image data;
a character recognition module, determining whether the at least one corresponding marker appears in at least one specific region on a frame of the first streaming image, and providing an enable signal when the at least one corresponding marker appears in the at least one specific region on the frame; and
an object recognition module, performing the object recognition according to the enable signal and the second streaming image.

7. The object recognition device according to claim 6, wherein the character recognition module is an optical character recognition (OCR) artificial intelligence module, and the object recognition module performs the object recognition based on an artificial intelligence algorithm.

8. The object recognition device according to claim 6, wherein the character recognition module comprises a reference data comprising only a plurality of vocabularies in the at least one marker and a training dataset related to the reference data, and the image sensor has a camera lens with a single focal length.

9. The object recognition device according to claim 6, wherein the streaming image module temporarily stops transmitting the second streaming image to the object recognition module of the computing host based on the enable signal, so that the object recognition module suspends the object recognition on the frame corresponding to the image data.

10. The object recognition device according to claim 6, wherein the streaming image module adjusts the second streaming image to a sample image data based on the enable signal, and transmits the sample image data to the object recognition module of the computing host, so that the object recognition module suspends the object recognition on the frame corresponding to the image data.

11. An object recognition method, comprising:
using an image sensor to sense an imaging region to generate an image data, wherein the image sensor is disposed on a motorized pan-tilt mechanism, the motorized pan-tilt mechanism is configured to rotate the image sensor to adjust the imaging region of the image sensor, and at least one marker is fixed to the motorized pan-tilt mechanism;
receiving the image data from the image sensor;
determining whether the at least one corresponding marker appears in at least one specific region on a frame corresponding to the image data;
suspending an object recognition on the frame corresponding to the image data in response to the at least one corresponding marker not appearing in the at least one specific region; and
starting to perform the object recognition on the frame corresponding to the image data in response to the at least one corresponding marker appearing in the at least one specific region.

12. The object recognition method according to claim 11, wherein, in response to the at least one corresponding marker not appearing in the at least one specific region, the motorized pan-tilt mechanism is controlled to continue rotating, and
in response to the at least one corresponding marker appearing in the at least one specific region, the motorized pan-tilt mechanism is controlled to stop rotating within a predetermined time.

13. The object recognition method according to claim 11, wherein each of the at least one marker presents one or a combination of numbers, text, or symbols in a direction facing the image sensor.

14. The object recognition method according to claim 11, wherein the at least one specific region in the frame respectively corresponds to the at least one marker, and the computing host recognizes an object to be detected in the imaging region based on the at least one specific region and the at least one marker.

15. The object recognition method according to claim 14, wherein a distance between a camera lens of the image sensor and the at least one marker is less than a distance between the camera lens of the image sensor and the object to be detected.

16. The object recognition method according to claim 11, further comprising:
using a streaming image module to process the image data into a first streaming image and a second streaming image, wherein the first streaming image and the second streaming image are equivalent to the image data,
and the step of determining whether the at least one corresponding marker appears in the at least one specific region on the frame corresponding to the image data comprises:
using a character recognition module to determine whether the at least one corresponding marker appears in at least one specific region on a frame of the first streaming image, and providing an enable signal when the at least one corresponding marker appears in the at least one specific region on the frame; and
using an object recognition module to perform the object recognition according to the enable signal and the second streaming image.

17. The object recognition method according to claim 16, wherein the character recognition module is an optical character recognition (OCR) artificial intelligence module, and the object recognition module performs the object recognition based on an artificial intelligence algorithm.

18. The object recognition method according to claim 16, wherein the character recognition module comprises a reference data comprising only a plurality of vocabularies in the at least one marker and a training dataset related to the reference data, and the image sensor has a camera lens with a single focal length.

19. The object recognition method according to claim 16, wherein the step of suspending the object recognition on the frame corresponding to the image data comprises:
temporarily stopping transmitting the second streaming image to the object recognition module of the computing host based on the enable signal using the streaming image module.

20. The object recognition method according to claim 16, wherein the step of suspending the object recognition on the frame corresponding to the image data comprises:
adjusting the second streaming image to a sample image data based on the enable signal using the streaming image module, and transmitting the sample image data to the object recognition module of the computing host.
